(19) United States
(12) Patent Application Publication
(10) Pub. No.: US 2011/0304795 A1
(43) Pub. Date: Dec. 15, 2011

(54) BACKLIGHT ASSEMBLY AND DISPLAY APPARATUS INCLUDING THE SAME

(75) Inventors: Sang-Duk LEE, Asan-si (KR); So-Jeong NA, Busan (KR)

(73) Assignee: SAMSUNG ELECTRONICS CO., LTD., Suwon-si (KR)

(21) Appl. No.: 13/156,532

(22) Filed: Jun. 9, 2011

(30) Foreign Application Priority Data
Jun. 9, 2010 (KR) 10-2010-0054432

(51) Int. Cl. G02F 1/1335; F21V 7/22

(52) U.S. Cl. 349/62; 362/613

(57) ABSTRACT

A backlight assembly includes: a light guide plate (“LGP”); and a light source module which emits white light to a side surface of the LGP, where the light source module includes: a plurality of point light sources which emits the white light; a printed circuit board (“PCB”) including a mounting portion, on which the plurality of point light sources are disposed; and a light source housing portion including a base portion which supports the PCB, an extension portion which extends from a surface of the base portion in a direction perpendicular to the surface of the base portion and is disposed along the mounting portion, and a main stopper disposed adjacent to an end of the PCB, where the main stopper prevents the movement of the PCB within the light source module.

This application claims priority to Korean Patent Application No. 10-2010-0054432, filed on Jun. 9, 2010, and all the benefits accruing therefrom under 35 U.S.C. §119, the content of which in its entirety is herein incorporated by reference.

### BACKGROUND OF THE INVENTION

(1) Field of the Invention

The general inventive concept relates to a backlight assembly and a display apparatus including the same.

(2) Description of the Related Art

Liquid crystal displays (“LCD”s) are one of the most widely used types of flat panel displays (“FPD”s). Generally, an LCD includes two substrates having electrodes and a liquid crystal layer interposed between the substrates. In the LCD, voltages are applied to the electrodes to generate an electric field which rearranges liquid crystal molecules of the liquid crystal layer, thereby controlling the amount of light that passes through the liquid crystal layer.

Since the light transmittance of liquid crystal molecules is changed according to the orientation and intensity of an electric field applied to the liquid crystal molecules, LCDs require a light source to display an image. Most widely used light sources for LCDs may include light-emitting diodes (“LED”s), cold cathode fluorescent lamps (“CCFL”s) and flat fluorescent lamps (“FFL”s).

In edge-type backlight assemblies in which light is incident from point light sources onto a side surface of a light guide plate (“LGP”), the distance between light-emitting surfaces of the point light sources and an incident surface of the LGP may not be maintained as a constant distance because the LGP may be deformed by external conditions such as ambient temperature and humidity, for example.

### BRIEF SUMMARY OF THE INVENTION

Exemplary embodiments relates to a backlight assembly in which a distance between light-emitting surfaces of point light sources and an incident surface of a light guide plate (“LGP”) is maintained substantially constant and which prevents the light-emitting surfaces of the point light sources from being damaged due to a physical contact between the incident surface of the LGP and the light-emitting surfaces of the point light sources.

Another exemplary embodiment relates to a display apparatus including the backlight assembly.

In one exemplary embodiment, a backlight assembly includes: an LGP; and a light source module which emits white light to a side surface of the LGP, where the light source module includes: a plurality of point light sources which emits the white light; a printed circuit board (“PCB”) including a mounting portion on which the plurality of point light sources is disposed; and a light source housing portion including a base portion which supports the PCB, an extension portion which extends from a surface of the base portion in a direction substantially perpendicular to the surface of the base portion and is disposed along, and substantially parallel to, the mounting portion, and a main stopper which is disposed adjacent to an end of the PCB, where to the main stopper prevents the movement of the PCB within the light source module.

In one exemplary embodiment, the main stopper may include a first support portion which contacts a side surface of the end of the printed circuit board, and a second support portion which partially overlaps the mounting portion of the printed circuit board and contacts the side surface of the light guide plate.

In one exemplary embodiment, the first support portion and the second support portion may protrude from the surface of the base portion, and an end of the first support portion and an end of the second support portion may substantially perpendicularly intersect, and be coupled to, each other.

In one exemplary embodiment, each of the first support portion and the second support portion may include a body and a fixing member, where a through hole, through which the fixing member passes, is formed in the body.

In one exemplary embodiment, an end of the first support portion and an end of the second support portion may substantially perpendicularly intersect, and be coupled to, each other.

In one exemplary embodiment, the first support portion and the second support portion may be separated from each other.

In one exemplary embodiment, a coupling hole, to which the fixing member is coupled, may be formed in an area of the base portion which corresponds to a middle portion of the body of each of the first support portion and the second support portion.

In one exemplary embodiment, the main stopper may protrude from a surface of a mold frame disposed on the light source module and be coupled to the end of the printed circuit board.

In one exemplary embodiment, the main stopper may include a first support portion, a second support portion and a third support portion, each of which protrudes from the surface of the mold frame, where an end of each of the second support portion and the third support portion substantially perpendicularly intersects, and is coupled to, a corresponding one of both ends of the first support portion.

In one exemplary embodiment, the backlight assembly may further include auxiliary stoppers disposed on the base portion of the light source housing portion and arranged at predetermined intervals along the side surface of the light guide plate.

In one exemplary embodiment, the backlight assembly may further include a buffer member interposed between a rear portion of the printed circuit board, which faces the mounting portion of the printed circuit board, and the extension portion of the light source housing portion.

In one exemplary embodiment, the buffer member may include a plurality of buffer elements arranged at predetermined intervals along the rear portion of the printed circuit board.

In one exemplary embodiment, the buffer member may be a linear buffer member which extends along the rear portion of the printed circuit board.

In an alternative exemplary embodiment, a backlight assembly includes: an LGP which extends in a first plane direction; and a light source module which emits white light to a side surface of the LGP, where the light source module includes: a light source housing portion including a base portion which extends in the first plane direction and an extension portion which extends in a second plane direction substantially perpendicular to the first plane direction; a PCB including a plurality of point light sources, which emit white light to the side surface of the LGP, disposed thereon, where the PCB extends in the second plane direction; and a buffer member interposed between the PCB and the extension portion.

In one exemplary embodiment, the backlight assembly may further include a main stopper connected to the base portion and which contacts and supports at least one surface of the printed circuit board, where the main stopper prevents a movement of the printed circuit board within the light source module.

In one exemplary embodiment, the main stopper may include a first support portion which contacts a surface of the printed circuit board, on which the point light sources are mounted, and a second support portion which contacts a side surface of the printed circuit board.

In one exemplary embodiment, the main stopper may protrude from a surface of a mold frame disposed on the light source module and the main stopper may be coupled to an end of the printed circuit board.

In one exemplary embodiment, the backlight assembly may further include auxiliary stoppers disposed on the base portion of the light source housing portion and arranged at predetermined intervals along the side surface of the light guide plate.

In another exemplary embodiment, a display apparatus includes: a display panel; and a backlight assembly which provides white light to the display panel, where the backlight assembly includes an LGP and a light source module which emits the white light to a side surface of the LGP, where the light source module includes: a plurality of point light sources which emits the white light; a PCB including a mounting portion on which the point light sources are disposed; and a light source housing portion including a base portion which supports the PCB, an extension portion which extends from a surface of the base portion in a direction substantially perpendicular to the surface of the base portion and is disposed along, and substantially parallel to, the mounting portion, and a main stopper which is disposed adjacent to an end of the PCB, where the main stopper prevents the movement of the PCB within the light source module.

In an alternative exemplary embodiment, a display apparatus includes: a display panel; and a backlight assembly which provides white light to the display panel, where the backlight assembly includes an LGP and a light source module which emits the white light to a side surface of the LGP, and where the light source module includes: a light source housing portion including a base portion which extends in a first plane direction and an extension portion which extends in a second plane direction substantially perpendicular to the first plane direction; a PCB having a plurality of point light sources, which emit white light to the side surface of the LGP, disposed thereon, where the PCB extends in the second plane direction; and a buffer member interposed between the PCB and the extension portion.

### BRIEF DESCRIPTION OF THE DRAWINGS

The above and other aspects and features of the present inventive concept will become more apparent by describing in further detail exemplary embodiments thereof with reference to the attached drawings, in which:

FIG. 1 is an exploded perspective view of an exemplary embodiment of a display apparatus including a backlight assembly according to the present invention;

FIGS. 2A and 2B are enlarged top plan views of portion A of FIG. 1;

FIGS. 3 through 5B are partial top plan views of alternative exemplary embodiments of the backlight assembly according to the present invention; and

FIG. 6 is a cross-sectional view taken along line I-I′ of the display apparatus of FIG. 1.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on” another element, it can be directly on another element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the actual shape of a region of a device and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

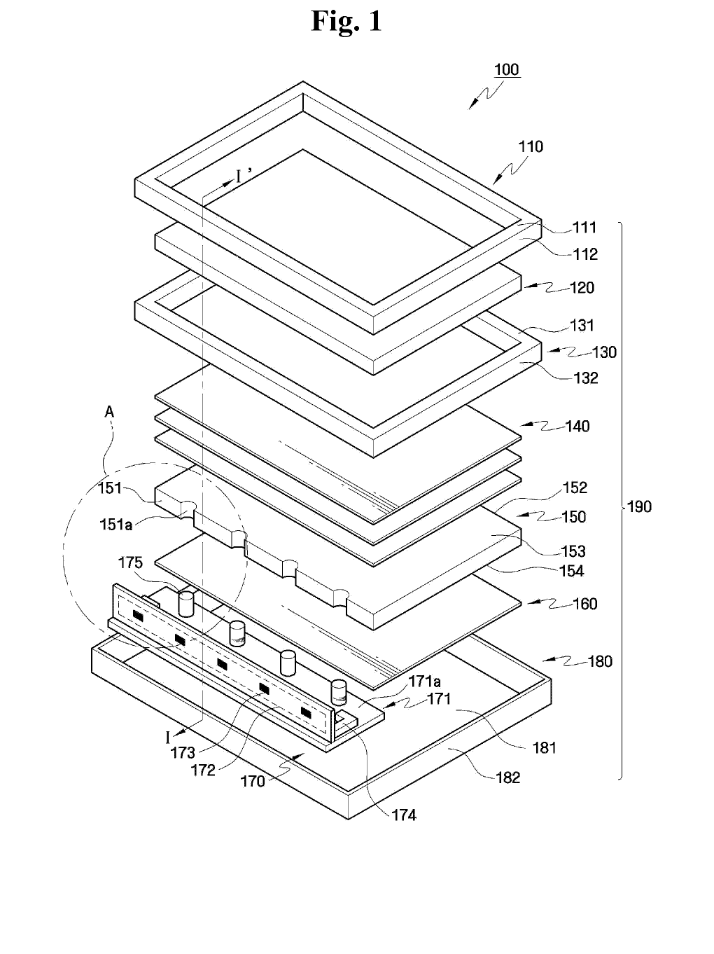

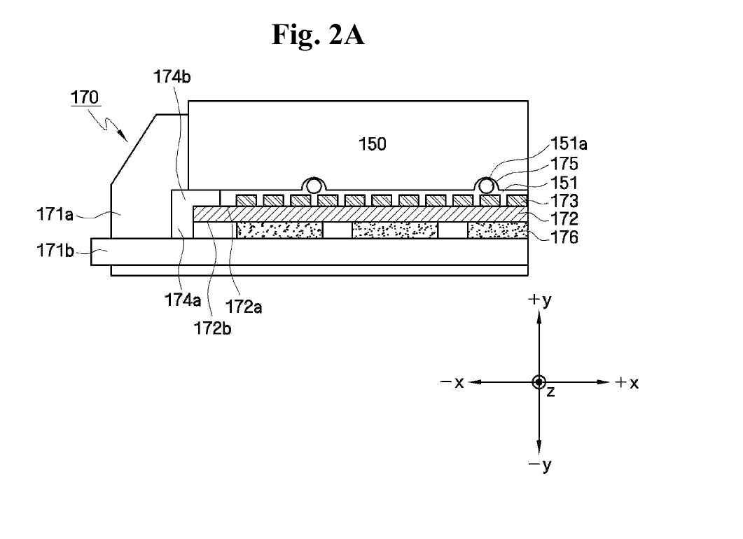

FIG. 1 is an exploded perspective view of an exemplary embodiment of a display apparatus 100 including a backlight assembly 190 according to the present invention. FIGS. 2A and 2B are enlarged top plan views of portion A of FIG. 1.

Referring now to FIG. 1, an exemplary embodiment of the backlight assembly 190 includes a light guide plate (“LGP”) 150 and a light source module 170.

The LGP 150 includes an incident surface 151 to which light emitted from the light source module 170, which will be described later in greater detail, is incident, a facing surface 152 which faces the incident surface 151, an output surface 153 which connects the incident surface 151 to the facing surface 152 and from which light is transmitted to a liquid crystal display panel 120, and a reflective surface 154 which faces the output surface 153.

The LGP 150 may guide light emitted from the light source module 170 to a side surface of the LGP 150 toward the liquid crystal display panel 120 as an optical waveguide. Light transmitted inside of the LGP 150 may not pass through a surface of the LGP 150 in contact with air outside the LGP 150 when an incident angle of the light with respect to the surface of the LGP 150 is greater than a critical angle of the LGP 150 because the light may be totally reflected by the surface of the LGP due to the difference between the refractive index of the LGP 150 and the refractive index of the outside air, and thus the light is substantially evenly delivered within the entire inner portion of the LGP 150.

In an exemplary embodiment, the LGP 150 may be a plate-type or wedge-type LGP made of a plastic-based transparent material. In an alternative exemplary embodiment, the LGP 105 may be made of a transparent material including acrylic resin, such as polymethyl methacrylate (“PMMA”) and polycarbonate, for example.

The light source module 170 includes a plurality of point light sources 173, a printed circuit board (“PCB”) 172 on which the point light sources 173 are disposed, and a light source housing portion 171 which fixes the PCB 172 to a determined position.

In an exemplary embodiment, the light source module 170 may be disposed substantially adjacent to the incident surface 151 of the LGP 150 in the backlight assembly 190. The incident surface 151 may be longer than the reflective surface 154. The plurality of point light sources 173 may be light-emitting diodes (“LED”s) including a compound semiconductor.

When receiving a driving voltage from an external source, the plurality of point light sources 173 emits white light to the incident surface 151 of the LGP 150. In an exemplary embodiment, the plurality of point light sources 173 may emit white light by combining yellow phosphors with blue LEDs. In an alternative exemplary embodiment, the plurality of point light sources may emit white light by grouping LEDs of three primary colors, e.g., red, green and blue LEDs, together and mixing the three primary colors.

The PCB 172, on which the plurality of point light sources (e.g., LEDs) 173 are disposed, applies a driving voltage to each of the plurality of point light sources 173. The PCB 172 is substantially in the form of a rectangular parallelepiped and includes long sides which are substantially parallel to a long side of the incident surface 151, and short sides which are substantially orthogonal to the long sides of the incident surface 151. The plurality of point light sources 173 is disposed on a mounting portion 172a of the PCB 172 and arranged at predetermined intervals along the long sides of the PCB 172 to substantially uniformly provide white light to the incident surface 151. The PCB 172 may include a circuit pattern that electrically connects a terminal of each of the plurality of point light sources 173 and an external power supply circuit. The PCB 172 includes a rear portion 172b facing the mounting portion 172a, on which the plurality of point light sources 173 is disposed, and contacting buffer members 176 which will be described later.

The light source housing portion 171 accommodates the PCB 172, maintains a light incidence distance, which is defined as a distance between a plane defined by the incident surface 151 of the LGP 150 and a plane defined by light-emitting surfaces of the plurality of point light sources 173, at a predetermined distance, and transfers heat generated by the plurality of point light sources 173 to the outside.

Referring again to FIG. 1, the light source housing portion 171 includes a base portion 171a, on which a side surface of the PCB 172 is disposed, and an extension portion 171b, which protrudes from an upper surface of the base portion 171a in a direction substantially perpendicular to the upper surface of the base portion 171a and fixes the rear portion 172b of the PCB 172 to the light source housing portion 171. A region of the base portion 171a extends in a first direction, which is defined as a direction from the plurality of point light sources 173 to the incident surface 151 of the LGP 150, and partially overlaps the reflective surface 154 of the LGP 150. The other region of the base portion 171a extends in an opposite direction of the first direction and supports a side portion of a mold frame 130. The extension portion 171b of the light source housing portion 171 extends substantially parallel to the long sides of the PCB 172. The buffer members 176 are interposed between the extension portion 171b of the light source housing portion 171 and the rear portion 172b of the PCB 172 to fix the rear portion 172b of the PCB 172 in a predetermined position.

In an exemplary embodiment, the light source module further include main stopper 174 and auxiliary stopper 175 that are disposed on the base portion 171a of the light source housing portion 171. The main stopper 174 is disposed adjacent to a short side of the PCB 172, and the auxiliary stopper 175 is coupled to a coupling groove 151a formed on the incident surface 151 of the LGP 150.

The main stopper 174 may be disposed adjacent to each of both short sides of the PCB 172 of the light source module 170. The shape of the main stopper 174 disposed adjacent to one short side of the PCB 172 is shown in FIGS. 2A through 5 and will be described in greater detail. In an exemplary embodiment, the shape of the main stopper 174 disposed adjacent to the other short side of the PCB 172 may be substantially symmetrical to the shape of the main stopper 174 disposed adjacent to the one short side of the PCB 172. The main stopper 174 and the auxiliary stopper 175 prevent the movement of the PCB 172 and maintain the light incidence distance to be greater than a threshold distance.

An exemplary embodiment of shapes and functions of the main and auxiliary stoppers 174 and 175 will now be described in greater detail with reference to FIGS. 2A and 2B. FIGS. 2A and 2B are substantially identical to each other, except for the shape of the buffer members 176.

Referring now to FIGS. 2A and 2B, the LGP 150 extends in a first plane (x-y plane) direction. The base portion 171a of the light source housing portion 171 extends in the first plane (x-y plane) direction, and the extension portion 171b of the light source housing portion 171 extends in a second plane (x-z plane) direction substantially perpendicular to the first plane (x-y plane) direction. The PCB 172 is disposed on the base portion 171a to lean on the buffer members 176 and extends substantially parallel to the extension portion 171b in the second plane (x-z plane) direction. Accordingly, the plurality of point light sources 173 disposed on the PCB 172 emits white light in the first direction (+y direction).

In an exemplary embodiment, the main stopper 174 may be integrally formed on the light source housing portion 171. The main stopper 174 is disposed adjacent to a short side of the PCB 172. The main stopper 174 includes a first support portion 174a and a second support portion 174b which protrude from the upper surface of the base portion 171a of the light source housing portion 171 in the direction substantially perpendicular to the upper surface of the base portion 171a. The first support portion 174a contacts a side surface of a short side of the PCB 172, and the second support portion 174b partially overlaps the mounting portion 172a of the PCB 172. The first support portion 174a and the second support portion 174b may intersect substantially perpendicularly to each other. The main stopper 174 is disposed adjacent to a short side of the PCB 172 to prevent the vertical or horizontal movement of the PCB 172 along with the buffer members 176 that support the PCB 172 with a constant elastic force in the first direction (+y direction or −y direction), and thereby to fix the position of the light-emitting surfaces of the plurality of point light sources 173. Here, the vertical direction indicates the first direction (+y or −y direction), and the horizontal direction indicates a direction (+x or −x direction) substantially perpendicular to the first direction.

The auxiliary stopper 175 may include at least one protrusion disposed at a predetermined interval on the upper surface of the base portion 171a of the light source housing portion 171 to be coupled to the coupling groove 151a formed on the incident surface 151 of the LGP 150. The auxiliary stopper 175 is coupled to the coupling groove 151a of the LGP 150 and assists the main stopper 174 to maintain a distance between the incident surface 151 of the LGP 150 and the light-emitting surface of the plurality of point light sources 173. In an exemplary embodiment, a shape of the protrusion may in the form of a circular cylinder, as shown in FIGS. 1, 2A and 2B. However, the shape of the protrusion is not limited to the cylindrical shape and may vary according to a shape of the coupling groove 151a.

The main stopper 174 and the auxiliary stopper 175 maintain the light incidence distance to be greater than a threshold distance. The LGP 150, which functions as an optical waveguide, may expand due to external conditions, for example, under high temperature and high humidity. When the LGP 150 expands, the incident surface 151 of the LGP 150 may contact the light-emitting surfaces of the point light sources 173, thereby causing mechanical friction therebetween. The mechanical friction may result in damage to the light-emitting surfaces of the plurality of point light sources 173. The damaged light-emitting surfaces of the plurality of point light sources 173 may reduce the incidence efficiency of white light emitted therefrom, and the display luminance of the display apparatus 100 (e.g., a liquid crystal display (“LCD”)) may be thereby reduced.

Accordingly, the main stopper 174 and the auxiliary stopper 175 maintain the light incidence distance to be greater than a threshold distance to prevent the incident surface 151 from contacting the light-emitting surfaces of the point light sources 173 and to maintain a predetermined level of light incidence efficiency.

In an exemplary embodiment, a width of the main stopper 174, that is, a distance from a surface of the extension portion 171b of the light source housing portion 171 to an outer surface of the second support portion 174b in the first direction (the +y direction), may be greater than a distance from the surface of the extension portion 171b to the light-emitting surfaces of the plurality of point light sources 173 to maintain the light incidence distance to be greater than the threshold distance. As shown in FIGS. 2A and 2B, the main stopper 174 functions as a stopper such that when the LGP 150 gradually expands in the opposite direction (the −y direction) of the first direction, a portion of the incident surface 151 of the LGP, which is located at a position corresponding to the position of the second support portion 174b of the main stopper 174, contacts the outer surface of the second support portion 174b, and the outer surface of the second support portion 174b thereby hinders the incident surface 151 of the LGP from further approaching the light-emitting surfaces of the point light sources 173. Although a shape of an exemplary embodiment of the main stopper 174 is shown in FIGS. 2A and 2B, the shape of the main stopper 174 may be variously modified to perform the function of the main stopper 174 described above.

A surface of each of the buffer members 176 contacts the rear portion 172b of the PCB 172, and the other surface of each of the buffer members 176 contacts the extension portion 171b of the light source housing portion 171. The buffer members 176 provide a repulsive force to the PCB 172 such that the PCB 172 is fixed in a predetermined position by the main stopper 174. In an exemplary embodiment, the buffer members 176 may effectively prevent the non-uniformity of the light incidence distance which may arise from the assembly tolerance of the main stopper 174. The buffer members 176 may be made of a silicon material having good elasticity or a rubber material. In addition, the buffer members 176 may include a material having high thermal conductivity to transfer heat generated by the plurality of point light sources 173 to the light source housing portion 171 which may be made of a metal material. In an exemplary embodiment, each of the buffer members 176 may include contact members, such as double-sided tapes, on both surfaces thereof in the first direction to increase the adhesion between the PCB 172 and the light source housing portion 171. In an exemplary embodiment, each of the buffer members 176 may be substantially in the shape of hexahedral prism and arranged at predetermined intervals, as shown in FIG. 2A. In an alternative exemplary embodiment, as shown in FIG. 2B, the buffer members 176 may be a single unit which extends along the rear portion 172b of the PCB 172 to increase a heat dissipation effect.

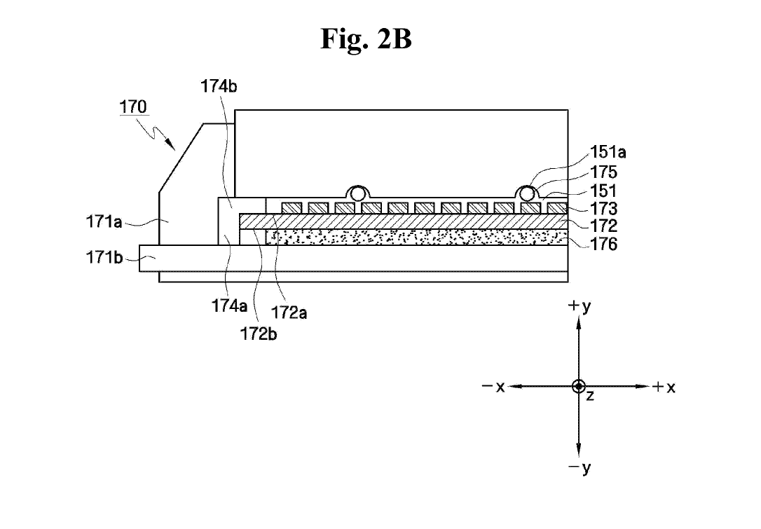

FIG. 3 is a partial top plan view of an alternative exemplary embodiment of a backlight assembly according to the present invention. The backlight assembly in FIG. 3 is substantially the same as the backlight assembly shown in FIGS. 2A and 2B except that the main stopper 174 of FIG. 3 is not integrally formed on a light source housing portion 171. The same or like elements shown in FIG. 3 have been labeled with the same reference characters as used above to describe the exemplary embodiments of the backlight assembly shown in FIGS. 2A and 2B, and any repetitive detailed description thereof will hereinafter be omitted or simplified.

Referring to FIG. 3, a main stopper 174 has the same shape as the main stopper 174 shown in FIGS. 2A and 2B. However, as described above, the main stopper 174 of FIG. 3 is not integrally formed on a light source housing portion 171. The main stopper 174 includes a body and fixing members 174a-1 and 174b-1 coupled to the body. The body of the main stopper 174 may include materials (e.g., polycarbonate) which are different from a material included in the light source housing portion 171 and may be fixed to a base portion 171a of the light source housing portion 171 by the fixing members 174a-1 and 174b-1 such as screws, for example.

As shown in FIG. 3, the body of the main stopper 174 includes a first support portion 174a and a second support portion 174b which are coupled to each other. A through hole (not shown) is formed in a portion of each of the first and second support portions 174a and 174b. Each of the fixing members 174a-1 and 174b-1 is inserted into the through hole, and thus coupled to the base portion 171a of the light source housing portion 171. In addition, a coupling hole (not shown) is formed on the base portion 171a of the light source housing portion 171, and an end of each of the fixing members 174a-1 and 174b-1 inserted into the through holes of the body of the main stopper 174 is coupled to the coupling hole.

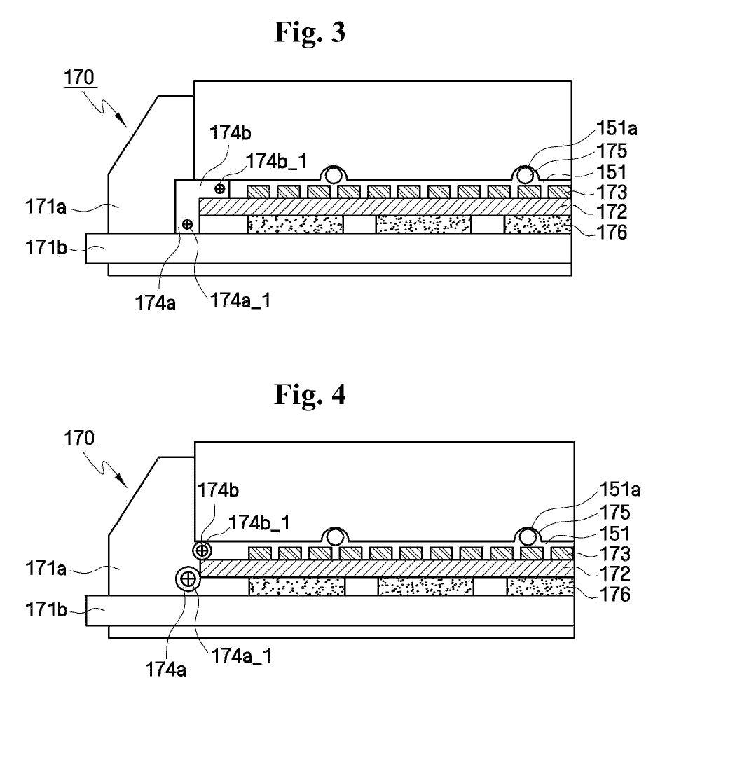

FIG. 4 is a partial top plan view of another alternative exemplary embodiment of the backlight assembly. The backlight assembly in FIG. 4 is substantially the same as the backlight assembly shown in FIGS. 2A and 2B except for the main stopper. The same or like elements shown in FIG. 4 have been labeled with the same reference characters as used above to describe the exemplary embodiments of the backlight assembly shown in FIGS. 2A and 2B, and any repetitive detailed description thereof will hereinafter be omitted or simplified.

Referring to FIG. 4, a main stopper 174 includes a first support portion 174a which contacts a side surface of a short side of a PCB 172 and a second support portion 174b which is separated from the first support portion 174a and contacts part of a mounting portion 172a of the PCB 172. Each of the first and second support portions 174a and 174b includes a body and a fixing member 174a-1 or 174b-1 which may be integrally coupled to the body. The body of each of the first and second support portions 174a and 174b may be substantially in the shape of circular cylinder, hexahedral or hexagonal prism. A through hole (not shown) is formed through the middle portion of the body of each of the first and second support portions 174a and 174b such that one of the fixing members 174a-1 and 174b-1 passes through the through hole to be fixed to a coupling hole formed on a base portion 171a of a light source housing portion 171 located under a bottom surface of the body of each of the first and second support portions 174a and 174b. In an exemplary embodiment, the fixing members 174a-1 and 174b-1 that couple the bodies of the first and second support portions 174a and 174b to the base portion 171a of the light source housing portion 171 may be screws, but not being limited thereto. In an alternative exemplary embodiment, the fixing members 174a-1 and 174b-1 may be rivets, for example.

Since the main stopper 174 of FIG. 4 includes two separate bodies differently from the main stopper 174 of FIG. 3, a manufacturing cost for the main stopper 174 may be effectively reduced. To maintain a constant light incidence distance, the main stopper 174 of FIG. 4 may be structured such that a distance from a surface of an extension portion 171b of the light source housing portion 171 to an outer surface of the body of the second support portion 174b in the first direction (+y direction) is greater than a distance from the surface of the extension portion 171b of the light source housing portion 171 to light-emitting surfaces of the plurality of point light sources 173 (e.g., LEDs).

The auxiliary stopper 175 may be variously modified. For example, in one alternative exemplary embodiment, instead of being integrally formed on the light source housing portion 171 as shown in FIGS. 3 and 4, each of the auxiliary stoppers 175 may have a body which has a certain pillar shape and a fixing member which is coupled to the body so as to fix the body to the base portion 171a of the light source housing portion 171.

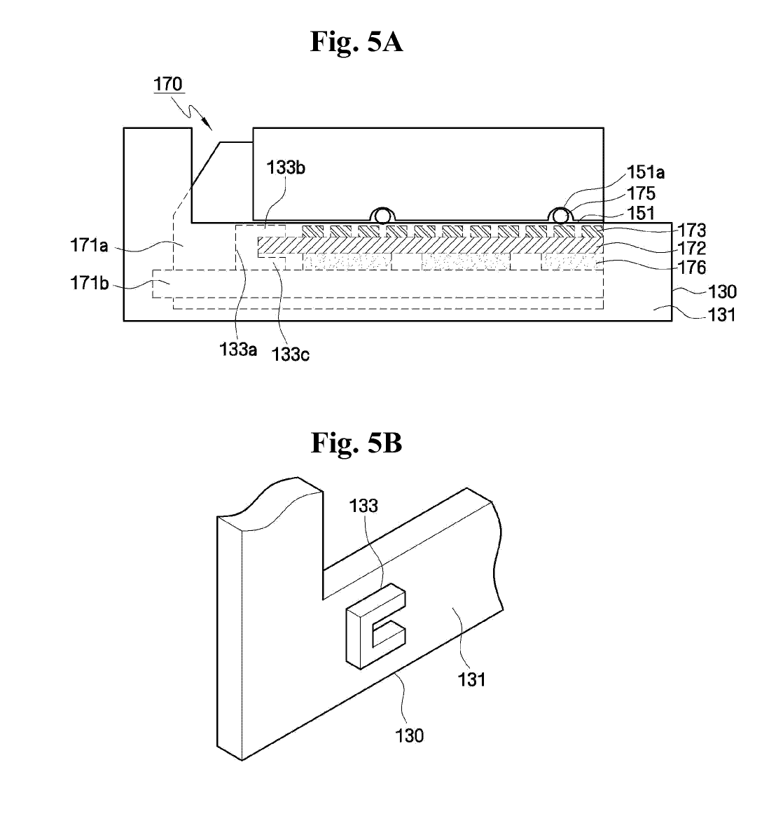

FIG. 5A is a partial top plan view of yet another alternative exemplary embodiment of the backlight assembly. FIG. 5B is a perspective view of a main stopper 133 shown in FIG. 5A. The backlight assembly in FIGS. 5A and 5B is substantially the same as the backlight assembly shown in FIGS. 2A and 2B except for the main stopper 133. The same or like elements shown in FIGS. 5A and 5B have been labeled with the same reference characters as used above to describe the exemplary embodiments of the backlight assembly shown in FIGS. 2A and 2B, and any repetitive detailed description thereof will hereinafter be omitted or simplified.

Referring again to FIG. 1 and as shown in 5A and 5B, a main stopper 174 is disposed on a lower surface of a quadrangular frame portion 131 of the mold frame 130 of FIG. 1. Referring to FIG. 1, the mold frame 130 includes the quadrangular frame portion 131 and four side portions 132 which extend from the frame portion 131 in the direction of a housing 180. The liquid crystal display panel 120 is disposed on an upper surface of the frame portion 131, and optical sheets 140 and the LGP 150 are sequentially disposed on a lower surface of the frame portion 131. Fixing protrusions (not shown) may further be disposed on inner surfaces of the four side portions 132 and may be coupled to movement preventing grooves (not shown) formed in the LGP 150.

In an exemplary embodiment, the main stopper 174 may be formed integrally on part of the lower surface of the frame portion 131 of the mold frame 130 to prevent the movement of a PCB 172, wherein a light source module 170 is disposed under the frame portion 131. A shape of an exemplary embodiment of the main stopper 174 is as shown in FIG. 5B. The main stopper 174 includes first through third support portions 133a through 133c which protrude from the lower surface of the mold frame 130 in the direction of a base portion 171a of the light source housing portion 171. An end of each of the second and third support portions 133b and 133b substantially perpendicularly intersects a corresponding end of the first support portion 133a, respectively. Referring to FIG. 5A, the second and third support portions 133b and 133c face each other with the PCB 172 interposed therebetween, and a short side of the PCB 172 is inserted into a space between the second and third support portions 133b and 133c.

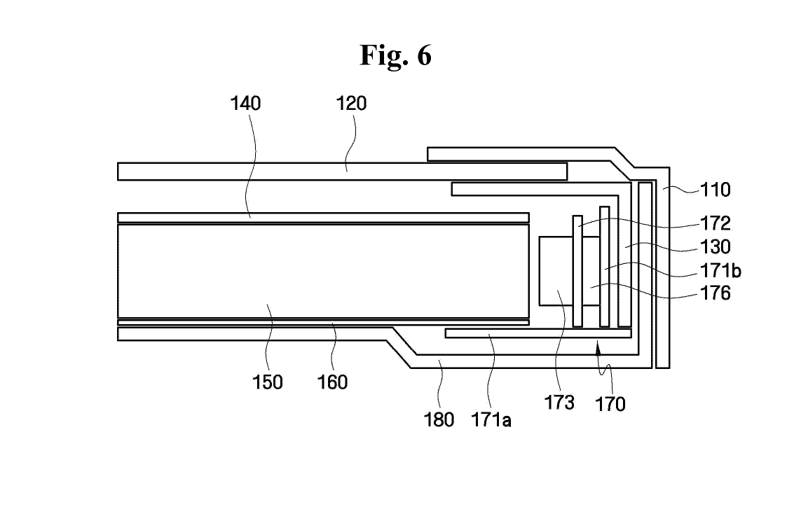

Exemplary embodiments of the liquid crystal display panel 120, the optical sheets 140, a reflective sheet 160, the housing 180 and a display apparatus cover 110 included in the display apparatus 100 will now be described with reference to FIGS. 1 through 6.

The liquid crystal display panel 120 includes a lower display substrate (not shown) having gate lines, data lines, a thin-film transistor (“TFT”) array, pixel electrodes, and the like, an upper display substrate which faces the lower display substrate, and a liquid crystal layer which is interposed between the upper and lower display substrates. The liquid crystal display panel 120 displays image information using white light provided by the backlight assembly 190 disposed thereunder.

The reflective sheet 160 is disposed between the reflective surface 154 of the LGP 150 and a bottom plate 181 of the housing 180 and reflects light emitted from the reflective surface 154 of the LGP 150 in an upward direction. The reflective sheet 160 reflects light which has failed to be reflected by diffusion patterns disposed on the reflective surface 154 of the LGP 150, thereby substantially reducing the loss of light that is to be incident on the liquid crystal display panel 120 while substantially improving the uniformity of light passing through the output surface 153 of the LGP 150. In an exemplary embodiment, the reflective sheet 160 may be made of, e.g., polyethylene terephthalate (“PET”). In an exemplary embodiment, a surface of the reflective sheet 160 may be coated with a diffusion layer including, e.g., titanium dioxide. When the titanium dioxide dries and settles, it forms a frost-like white surface which diffuses light more uniformly and provides substantial reflection effect.

In an exemplary embodiment, the optical sheets 140 may be disposed on the LGP 150 to diffuse and concentrate light received from the LGP 150. The optical sheets 140 include a diffusion sheet, a prism sheet, a reflective polarizing sheet, a protective sheet and other sheets having similar optical characteristics. In an exemplary embodiment, the diffusion sheet may be disposed between the LGP 150 and the prism sheet diffuses light incident from the LGP 150, thereby effectively preventing the light from being concentrated in a specific area. The prism sheet has a predetermined array of triangular prisms on an upper surface thereof. The prism sheet typically includes two sheets, and an array of triangular prisms formed on one of the two prism sheets cross an array of triangular prisms formed on the other one of the two prism sheets at a predetermined angle such that light diffused by the diffusion sheet is concentrated in a direction substantially perpendicular to the liquid crystal display panel 120. Accordingly, a substantial portion of the light that passes through the prism sheet proceeds vertically, resulting in uniform luminance distribution on the protective sheet.

In an exemplary embodiment, the reflective polarizing sheet may be disposed on the prism sheet polarizes and reflect light having a predetermined phase to increase the luminance of the light provided to the liquid crystal display panel 120. The reflective polarizing sheet may protect the surface of the prism sheet and diffuse light for uniform distribution of the light.

The housing 180 includes the quadrangular bottom plate 181 and sidewalls 182 which extend from edges of the bottom plate 181, respectively, to form a housing space. In an exemplary embodiment, the light source module 170, the reflective sheet 160, the LGP 150 and the optical sheets 140 may be sequentially accommodated in the housing space of the housing 180. Coupling protrusions (not shown) may be disposed on the sidewalls 182 of the housing 180 to couple and fix the housing 180 to the mold frame 130. In addition, coupling holes (not shown) may be disposed in the side portions 132 of the mold frame 130 at positions corresponding respectively to positions of the coupling protrusions.

The display apparatus cover 110 may include an aperture which corresponds to an image display area of the liquid crystal display panel 120, a quadrangular frame portion 111 and side portions 112 which extend from the frame portion 111 and are coupled to the sidewalls 182 of the housing 180. A surface of the frame portion 111 overlaps edges of the upper display substrate of the liquid crystal display panel 120 to support the liquid crystal display panel 120.

While the present inventive concept has been particularly shown and described with reference to exemplary embodiments thereof, it will be understood by those of ordinary skill in the art that various changes in form and detail may be made therein without departing from the spirit and scope of the present inventive concept as defined by the following claims. The exemplary embodiments should be considered in a descriptive sense only and not for purposes of limitation.

What is claimed is:

1. A backlight assembly comprising:
a light guide plate; and
a light source module which emits white light to a side surface of the light guide plate,
wherein the light source module comprises:
a plurality of point light sources which emits the white light;
a printed circuit board comprising a mounting portion on which the plurality of point light sources is disposed; and
a light source housing portion comprising:
a base portion which supports the printed circuit board;
an extension portion which extends from a surface of the base portion in a direction substantially perpendicular to the surface of the base portion and is disposed along, and substantially parallel to, the mounting portion of the printed circuit board; and
a main stopper disposed adjacent to an end of the printed circuit board, wherein the main stopper prevents a movement of the printed circuit board within the light source module.

2. The backlight assembly of claim 1, wherein the main stopper comprises:
a first support portion which contacts a side surface of the end of the printed circuit board; and
a second support portion which partially overlaps the mounting portion of the printed circuit board and contacts the side surface of the light guide plate.

3. The backlight assembly of claim 2, wherein
the first support portion and the second support portion protrude from the surface of the base portion, and
an end of the first support portion and an end of the second support portion substantially perpendicularly intersect, and are coupled to, each other.

4. The backlight assembly of claim 2, wherein each of the first support portion and the second support portion comprises a body and a fixing member, wherein a through hole, through which the fixing member passes, is formed in the body.

5. The backlight assembly of claim 4, wherein an end of the first support portion and an end of the second support portion substantially perpendicularly intersect, and are coupled to, each other.

6. The backlight assembly of claim 4, wherein the first support portion and the second support portion are separated from each other.

7. The backlight assembly of claim 4, wherein a coupling hole, to which the fixing member is coupled, is formed in an area of the base portion which corresponds to a middle portion of the body of each of the first support portion and the second support portion.

8. The backlight assembly of claim 1, wherein the main stopper protrudes from a surface of a mold frame disposed on the light source module and is coupled to the end of the printed circuit board.

9. The backlight assembly of claim 8, wherein
the main stopper comprises a first support portion, a second support portion and a third support portion, each of which protrudes from the surface of the mold frame, wherein an end of each of the second support portion and the third support portion substantially perpendicularly intersects, and is coupled to, a corresponding one of both ends of the first support portion.

10. The backlight assembly of claim 1, further comprising auxiliary stoppers disposed on the base portion of the light source housing portion and arranged at predetermined intervals along the side surface of the light guide plate.

11. The backlight assembly of claim 1, further comprising a buffer member interposed between a rear portion of the printed circuit board, which faces the mounting portion of the printed circuit board, and the extension portion of the light source housing portion.

12. The backlight assembly of claim 11, wherein the buffer member comprises a plurality of buffer elements arranged at predetermined intervals along the rear portion of the printed circuit board.

13. The backlight assembly of claim 11, wherein the buffer member is a linear buffer member which extends along the rear portion of the printed circuit board.

14. A backlight assembly comprising:
a light guide plate which extends in a first plane direction; and
a light source module which emits white light to a side surface of the light guide plate,
wherein the light source module comprises:
a light source housing portion comprising:
a base portion which extends in the first plane direction; and
an extension portion which extends in a second plane direction substantially perpendicular to the first plane direction;
a printed circuit board including a plurality of point light sources, which emits white light to the side surface of the light guide plate, disposed thereon and wherein the printed circuit board extends in the second plane direction; and
a buffer member interposed between the printed circuit board and the extension portion.

15. The backlight assembly of claim 14, further comprising a main stopper connected to the base portion and which contacts and supports at least one surface of the printed circuit board, wherein the main stopper prevents a movement of the printed circuit board within the light source module.

16. The backlight assembly of claim 15, wherein
the main stopper comprises a first support portion which contacts a surface of the printed circuit board, on which the point light sources are mounted, and a second support portion which contacts a side surface of the printed circuit board.

17. The backlight assembly of claim 15, wherein the main stopper protrudes from a surface of a mold frame disposed on the light source module and is coupled to an end of the printed circuit board.

18. The backlight assembly of claim 14, further comprising auxiliary stoppers disposed on the base portion of the light source housing portion and arranged at predetermined intervals along the side surface of the light guide plate.

19. A display apparatus comprising:
a display panel; and
a backlight assembly which provides white light to the display panel,
wherein the backlight assembly comprises:
a light guide plate; and
a light source module which emits the white light to a side surface of the light guide plate,
wherein the light source module comprises:
a plurality of point light sources which emits the white light;
a printed circuit board comprising a mounting portion on which the point light sources are disposed; and
a light source housing portion comprising:
a base portion which supports the printed circuit board;
an extension portion which extends from a surface of the base portion in a direction substantially perpendicular to the surface of the base portion and is disposed along, and substantially parallel to, the mounting portion; and
a main stopper which is disposed adjacent to an end of the printed circuit board, wherein the main stopper prevents a movement of the printed circuit board within the light source module.

20. A display apparatus comprising:
a display panel; and
a backlight assembly which provides white light to the display panel,
wherein the backlight assembly comprises a light guide plate and a light source module which emits the white light to a side surface of the light guide plate, and
wherein the light source module comprises:
a light source housing portion comprising a base portion which extends in a first plane direction and an extension portion which extends in a second plane direction substantially perpendicular to the first plane direction;
a printed circuit board having a plurality of point light sources, which emits white light to the side surface of the light guide plate, disposed thereon, wherein the printed circuit board extends in the second plane direction; and
a buffer member interposed between the printed circuit board and the extension portion.
